(19) United States
(12) Patent Application Publication
(10) Pub. No.: US 2025/0189216 A1
(43) Pub. Date: Jun. 12, 2025

(54) METHOD AND SYSTEM FOR PROVIDING GASEOUS COMPRESSED OXYGEN

(71) Applicant: LINDE GMBH, Pullach (DE)

(72) Inventor: Daniel PALANISWANY OTTE, Pullach (DE)

(21) Appl. No.: 18/842,209

(22) PCT Filed: Feb. 27, 2023
(86) PCT No.: PCT/EP2023/025087

§ 371 Date: Aug. 28, 2024

(30) Foreign Application Priority Data
Mar. 1, 2022 (EP) 22020083.6

(51) Int. Cl. F25J 1/00; F25J 1/02; F25J 3/04

(52) U.S. Cl. CPC F25J 1/0017; F25J 1/005; F25J 1/0072; F25J 1/0235; F25J 3/04169; F25J 2205/60; F25J 2205/86; F25J 2210/50; F25J 2220/02

(57) ABSTRACT

The invention relates to a method for providing high-pressure oxygen using low-pressure oxygen containing water, in which method the low-pressure oxygen is subjected to a drying process and subsequently to a pressure increase, the drying process comprising an adsorption step. In the adsorption step, a regeneration gas is used which is provided using oxygen that is provided using the pressure increase and using at least part of the low-pressure oxygen. The pressure increase is performed above 0° C. and using a plurality of compressors or compressor stages which have an intercooler between two compressors and/or compressor stages. At least part of the oxygen which is used to form the regeneration gas is removed from the pressure increase between two of the compressors or compressor stages upstream of the intercooler. Alternatively, the pressure increase is carried out by means of internal compression.

The invention relates to a method and to a system for providing gaseous compressed oxygen, in particular using electrolysis.

### BACKGROUND OF THE INVENTION

Oxygen can be produced by water electrolysis, especially as an additional product alongside hydrogen. For information on water electrolysis, reference is made to relevant specialist literature, for example to the article “Hydrogen” in Ullmann's Encyclopedia of Industrial Chemistry, Wiley-VCH, 15 Jun. 2000, DOI: 10.1002/14356007.a13_297, especially section 4.2, “Electrolysis.”

In certain electrolysis processes, oxygen is produced during water electrolysis at a lower pressure than desired. Many applications require oxygen at a pressure of 30 or 60 bar (abs.), for example, which is why oxygen must be compressed in these cases. Compression, in turn, typically requires the removal of water.

The present invention has for its object to improve the compression of oxygen, in particular of water-containing oxygen from water electrolysis, compared to the prior art.

### DISCLOSURE OF THE INVENTION

This object is achieved by a method and a system for producing gaseous compressed oxygen, in particular using electrolysis, having the features of the independent claims. The dependent claims and the following description specify embodiments.

In traditional water electrolysis, an aqueous alkaline solution, typically of potassium hydroxide, is used as the electrolyte (AEL, alkaline electrolysis). The electrolysis, which is carried out with a uni-or bipolar electrode arrangement, takes place at atmospheric pressure or—on an industrial scale-significantly higher. In some cases, subsequent compression may not be necessary.

More recent developments in water electrolysis include the use of proton-conducting ion exchange membranes (SPE, solid polymer electrolysis; PEM, proton exchange membranes), in which the water to be electrolyzed is provided on the anode side. Electrolysis technologies using an anion exchange membrane (AEM) are also used. In such methods, especially PEM, oxygen is produced at a lower pressure and therefore, as mentioned above, must be compressed if it is required at a correspondingly higher pressure.

The methods mentioned are low-temperature methods in which the water to be electrolyzed is present in the liquid phase. In addition, so-called steam electrolysis is also carried out, which can likewise be carried out with alkaline electrolytes (i.e., as AEL) with adapted membranes, for example polysulfone membranes, and using solid oxide electrolysis cells (SOEC). The latter comprise in particular doped zirconium dioxide or oxides of other rare earths which become conductive at high temperatures.

The term electrolysis will be used to refer to all of these methods. Low-temperature electrolysis (PEM, AEL, AEM) in particular is suitable for flexible operation, which supports the energy transition to renewable energies. All methods can be used in embodiments of the invention.

During water electrolysis, oxygen is typically formed with a certain (residual) water content, and the oxygen produced is water-saturated (depending on temperature and pressure). Another source of water can also come from a catalytic conversion of (residual) hydrogen. In the following, the term “oxygen” should therefore be understood not only to mean pure oxygen, but also an oxygen-rich gas mixture with an oxygen content of, for example, more than 90%, 95% or 99%, and in particular with a water content of typically 1% to 5% or more. As already mentioned, oxygen is saturated with water and therefore the water content in oxygen depends on pressure and temperature. The water content can therefore be determined using common calculation methods. All percentages used above and below refer to mass percent, volume percent, or mole percent.

In principle, embodiments of the present invention are not limited to the processing of electrolysis oxygen from water electrolysis, but can be used with oxygen, in particular of the composition just mentioned, from all conceivable sources.

The compression of the oxygen can, as is also possible in embodiments of the invention, be carried out with oxygen compressors (e.g., piston compressors), which, however, can only be operated with substantially anhydrous feed gas. Cryogenic liquefaction, purification, or compression-which are also possible in further embodiments of the invention—also require anhydrous feed gas, since water could freeze and block the heat exchangers used. Conventional methods have the disadvantage that the drying processes used greatly reduce the oxygen yield.

Against this background, the present invention proposes a method for producing gaseous high-pressure oxygen using water-containing, gaseous low-pressure oxygen, in which the low-pressure oxygen is subjected to a drying process and subsequently to an increase in pressure, wherein the drying process comprises an adsorption step which can be carried out in particular as an adsorption utilizing temperature or pressure changes. In this case, a regeneration gas is used in the adsorption, which is provided using oxygen, which is provided using the pressure increase and using at least a part of the low-pressure oxygen. After its use in the adsorption step in which it was loaded with water, the regeneration gas can, in embodiments of the invention, be subsequently returned to the method, particularly upstream of the drying process.

The term “regeneration gas” is used here to describe a gas that is used in the regeneration of an adsorbent used in an adsorption system or an adsorption step. Temperature swing adsorption involves a gas or gas mixture that is passed over the loaded adsorbent at an elevated temperature and absorbs the desorbing components. Pressure swing adsorption involves a gas or gas mixture by means of which the desorbed components are flushed out of the adsorbent after the pressure has been reduced for regeneration. The composition after appropriate use may be similar or identical in both cases.

In particular, a unification with fresh, water-containing oxygen can take place. In this case, condensative water separation can take place upstream of the drying process and downstream or upstream of the unification-upstream of which cooling can in particular take place. Condensative water separation upstream of the unification can occur, especially if hydrogen removal is not carried out. In this case, it may be intended to cool only the regeneration gas and then remove the water in a water separator. In particular, this return feed can increase the oxygen yield in embodiments of the invention. Separated water can, for example, be reused in an electrolysis process, if needed. Embodiments of the invention provide a significantly more cost-effective option for producing high-pressure/compressed oxygen, in particular from electrolysis, compared to the prior art.

Embodiments of the invention may in particular comprise that the regeneration is carried out under higher pressure than the adsorption in the adsorption step. In particular, the regeneration gas can be heated. In order to avoid an accumulation of, for example, carbon dioxide or other gases in the circulation, a partial blow-off/release from the process (“purge”) can also be carried out.

In embodiments of the invention, a regeneration gas containing water, which is formed in a regeneration in the adsorption step, can therefore be subjected to condensation to obtain an aqueous condensate fraction, wherein water cooling can be used in particular. More generally, water contained in the regeneration gas after its use in the adsorption step can be at least partially recycled into the method.

In embodiments of the invention, the condensate fraction can be fed without treatment or after treatment, for example to a water electrolysis, which is used to form the low-pressure oxygen. In one embodiment of the invention, a treatment can in particular comprise a thermal expulsion of gases, in particular argon and/or carbon dioxide, from the water—wherein fresh water supplied to the electrolysis is also subjected to the treatment. For example, a content of 5 to 10 ppm argon in the fresh water can be reduced to a content of less than 1 ppm, in particular less than 10 or 1 ppb, more particularly less than 0.1 ppb.

As is usual with electrolysis using a proton exchange membrane, the treatment can also be preceded by demineralization, which removes disruptive ions that can be created, in particular, by the materials used in the oxygen treatment.

In embodiments of the invention, the low-pressure oxygen is provided at a pressure in a first pressure range, the high-pressure oxygen is provided at a pressure in a second pressure range above the first pressure range, and the oxygen used to form the regeneration gas is provided using the pressure increase at a pressure in a third pressure range between the first and second pressure ranges or in the second pressure range. The pressure in the first pressure range corresponds in particular to the pressure of the adsorption in the adsorption step; the pressure in the third pressure range corresponds in particular to the pressure of the regeneration, as explained.

A person skilled in the art selects the pressure ranges in an appropriate manner. The pressure range for the regeneration, i.e., the third pressure range, is above the pressure of the oxygen to be regenerated, i.e., the pressure in the first pressure range, and is set so that the loaded regeneration gas stream has sufficient pressure to be returned. It is at least 200 mbar above the first pressure range.

In embodiments of the invention, at least a part of the oxygen used to form the regeneration gas can be taken from the pressure increase to the pressure in a third pressure range, or at least a part of the oxygen used to form the regeneration gas can be taken from the pressure increase to a pressure in a fourth pressure range above the third pressure range, and expanded to the pressure in the third pressure range.

In a first group of embodiments of the present invention, the pressure increase can be carried out above 0° C. and using a plurality of compressors or compressor stages, in particular a plurality of turbo compressors or turbo compressor stages or piston compressors or piston compressor stages. Embodiments of the invention enable an advantageous reduction in the water content, which is required for compression in such compressors or compressor stages.

In embodiments of the present invention which belong to the mentioned first group of embodiments, at least a part of the oxygen used to form the regeneration gas can be taken from the pressure increase between two of the compressors or compressor stages. In particular, extraction and, if necessary, throttling to a suitable pressure can take place. In particular, extraction can take place upstream and/or downstream of an intercooler provided between the two compressor stages. Especially when using temperature swing adsorption in the adsorption step, a warm extraction between compressor stages (before the intercooler) is advantageous because in this way the compression heat can be used for regeneration and the regeneration energy requirement can be reduced. A discharge downstream of an intercooler can be used to form a regeneration gas stream for a cooling step in the temperature swing adsorption. The regeneration gas can therefore be removed in particular during a heating phase in the adsorption step upstream of the intercooler and during the cooling phase in the adsorption step downstream of the intercooler.

In a second group of embodiments of the present invention, however, the pressure increase can comprise cryogenically liquefying at least a part of the low-pressure oxygen subjected to a drying process, and the subsequent pressure increase to obtain a cryogenic liquid, pressurizing at least a part of the cryogenic liquid in the liquid state to obtain a pressurized cryogenic liquid, and converting at least a part of the cryogenic and pressurized cryogenic liquid into the gaseous or supercritical state. The pressure increase can be carried out in a way that is comparable to an “internal compression,” as is basically known from the field of cryogenic air separation. Internal compression is explained, for example, in H.-W. Häring (Hrsg.), Industrial Gases Processing, Wiley-VCH, 2006 in Abschnitt 2.2.5.2, “Internal Compression.” It offers particular safety advantages. The pressure increase can be achieved by means of a pump or so-called run tanks, i.e., by means of pressure build-up evaporation, as described in particular in WO 2021/129948 A1.

In embodiments of the present invention which belong to the second group of embodiments mentioned, the cryogenic liquefaction can be carried out in particular using a heat exchanger operated with a nitrogen refrigeration circuit. For example, existing or externally supplied nitrogen can be used.

In embodiments of the present invention belonging to the mentioned first group of embodiments, a part of the pressurized cryogenic liquid and at least a part of the oxygen used to form the regeneration gas can be heated in the heat exchanger. In this way, particularly advantageous heat recovery is possible.

Although we have previously referred to a first and a second group of embodiments, it is understood that the embodiments and partial aspects thereof can also be combined with one another.

Embodiments of the invention may comprise intermediate storage of the cryogenic liquid in a liquid reservoir, which may be carried out in particular in certain operating modes. This enables a particularly advantageous adaptation to the given electricity supply and the given electricity price. For example, in a first operating mode at low energy prices, an excess of oxygen can be generated in an electrolysis and this excess and/or liquid nitrogen can be stored in a tank. In a second operating mode, however, so much oxygen is produced that its quantity covers the demand for high-pressure oxygen and does not exceed it. There is no storage in or removal from the tank. In a third operating mode in times of high electricity prices, however, a smaller amount of oxygen or no oxygen can be produced by electrolysis, and instead the demand for high-pressure oxygen can be at least partially covered from the liquid reservoir. In particular, a gas reservoir can be used when using liquid nitrogen.

In all embodiments explained, the low-pressure oxygen can be provided using electrolysis oxygen, which is provided using electrolysis. At least part of the electrolysis oxygen can be provided as hydrogen-containing electrolysis oxygen, wherein the hydrogen is at least partly converted to water using a catalytic hydrogen removal, which is followed by cooling and water separation, and in which the water (still present after the water separation) is at least partly removed in the drying process. The catalytic hydrogen removal can in particular be preceded by a heat exchanger which heats the low-pressure oxygen to a temperature which is at least 15° C. above the dew point and which in particular is driven predominantly or exclusively by electricity. Embodiments of the present invention are particularly suitable for use with corresponding electrolysis processes, since the oxygen is formed here as hydrous oxygen. For the reasons explained above, particular advantages arise in connection with electrolysis carried out using a proton exchange membrane.

A system for providing high-pressure oxygen using low-pressure oxygen containing water, which is designed to subject the low-pressure oxygen to drying process and subsequently to an increase in pressure and to carry out the drying process using an adsorption step, is also the subject of the present invention. This system is designed to use a regeneration gas in the adsorption step, to form the regeneration gas using oxygen, and to provide the oxygen used to form the regeneration gas using the pressure increase and using at least a part of the low-pressure oxygen.

With regard to the features and advantages of the system provided according to the invention and its embodiments, express reference is made to the features and advantages explained above in relation to the method according to the invention and its embodiments. This also applies to a system according to a particularly preferred embodiment of the present invention, which is designed to carry out a method as was described above and/or a corresponding embodiments.

In all embodiments of the present invention, it can be provided that the adsorption step, in particular a temperature swing adsorption, is preceded by a cooling, in particular with a cooling medium that is colder than the normal process cooling water (e.g., so-called chilled water of a refrigeration system) and a water separation, in order to achieve a reduction in the water content and to relieve the adsorption step accordingly in this way.

All embodiments of the present invention can comprise a first operating phase and a second operating phase, wherein an oxygen production, i.e., an amount of low-pressure oxygen provided, is lower in the second operating phase than in the first operating phase (so-called turn-down mode). The electrolysis is deactivated in the second operating phase or is operated at lower power. To ensure good flow through the catalysis for hydrogen removal, a minimum amount of gas must be passed through it. This strongly influences the size of the catalytic bed and increases the pressure loss of the catalytic reactor at full load. Therefore, in corresponding embodiments of the invention, it can be provided to recycle the regeneration gas stream after its use in the adsorption step in the second operating mode upstream of the catalytic hydrogen removal in order to ensure good flow there and to reduce the pressure loss for a full load (since the reactor can be designed sufficiently large and with a small pressure loss). In the first operating mode, recirculation can occur downstream of the catalytic hydrogen removal. Mixed forms are also possible.

The low-pressure oxygen can be supplied to the adsorption step without or with a further increase in temperature (the temperature increase of the oxygen compression may already be sufficient and a further increase in temperature, e.g., an electric heater, can be dispensed with.

The invention will be described further hereafter with reference to the accompanying drawings, which show embodiments of the present invention.

### BRIEF DESCRIPTION OF THE DRAWINGS

FIG. 1 shows a method according to an embodiment of the invention.

FIG. 2 shows a method according to an embodiment of the invention.

FIG. 3 shows water recirculation according to an embodiment of the invention.

FIG. 4 shows a cryogenic compression according to an embodiment of the invention.

In the figures, components corresponding functionally or structurally to one another as well as identical or comparable material streams are indicated by identical reference signs and, for the sake of clarity, are not repeatedly explained. Explanations regarding method steps also refer to corresponding devices or components of systems, and vice versa.

### DETAILED DESCRIPTION OF THE DRAWINGS

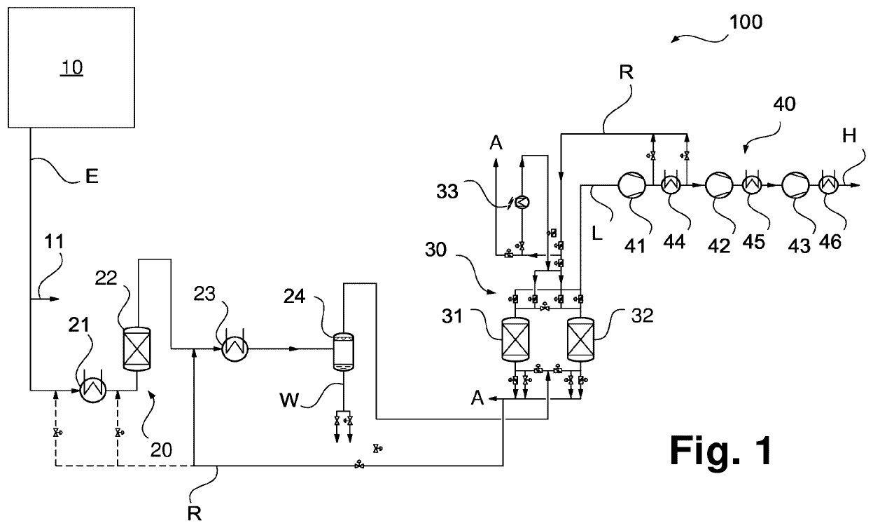

FIG. 1 shows a method 100 according to an embodiment of the invention in the form of a schematic process flow diagram.

In the method 100, using an electrolysis 10, for example using a proton exchange membrane, certain amounts of electrolysis oxygen E containing hydrogen are formed, in particular with a content of more than 98%. In an emergency, the electrolysis oxygen E can be released via a line 11 with a safety valve.

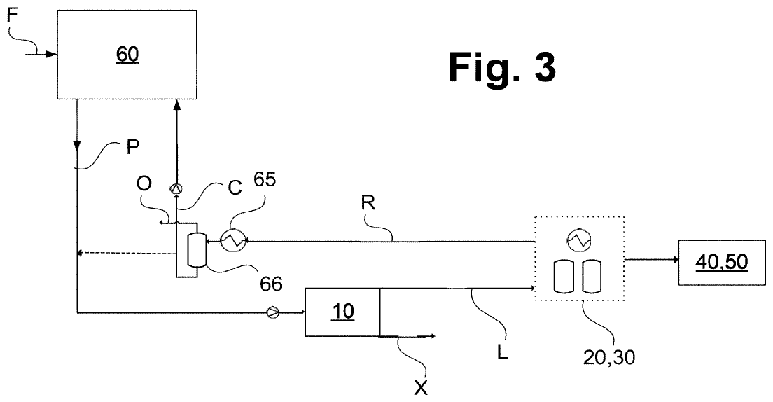

The overall hydrogen removal is designated by 20. It comprises, for example, an electric heater 21, with which a temperature delta of, for example, 25° C. can be operated. The appropriately heated oxygen is fed to a catalytic bed in a reactor 22, in which hydrogen is converted to water. After combining with a water-laden regeneration gas stream R, the water-containing oxygen is cooled in a cooler 23, which is operated, for example, with cooling water, and subjected to condensate separation in a condensate separator 24. A water stream W formed here can be recirculated, as illustrated in detail in FIG. 3.

However, oxygen partially freed from water in this way still contains a certain amount of water. It is referred to here as gaseous low-pressure oxygen and is illustrated with the reference symbol L. It is subjected to a total of 30 drying steps using temperature swing adsorption. In the drying process 30, a pair of adsorbers 31, 32 operated alternately is used. These are operated, for example, at an adsorption pressure of 4.5 bar and a regeneration pressure of 5 bar. Instead of temperature swing adsorption, pressure swing adsorption can also be carried out, as is generally known to the person skilled in the art and is therefore not separately illustrated. Whenever temperature swing adsorption is mentioned below, this should not be understood in a restrictive sense. The low-pressure oxygen, which has been freed from water in this way and is still designated by L, is then subjected to a total pressure increase designated by 40.

In the example illustrated here, three compressors or compressor stages 41, 42, 43 are used for the pressure increase, downstream of which intercoolers or aftercoolers 44, 45, 46 can be arranged. By increasing the pressure 40, compressed oxygen H is obtained and removed from the method.

In the example illustrated here, regeneration gas R is withdrawn between the compressors or compressor stages 41, 42 and, if necessary, throttled via valves not specifically designated, before it is heated to an adjustable extent in an electric heater 33 and passed through the adsorber 31, 32 to be regenerated. An output temperature of the regeneration gas can be adjusted by adjusting amounts withdrawn upstream and downstream of the intercooler 44. Parts of the regeneration gas may be released to atmosphere A before or after use for regeneration. Embodiments of the invention provide in particular for a return in the manner already explained above, i.e., upstream of the cooling in the cooler 23. Additional or alternative recirculation options are shown in dashed lines and illustrated upstream and downstream of the heater 21.

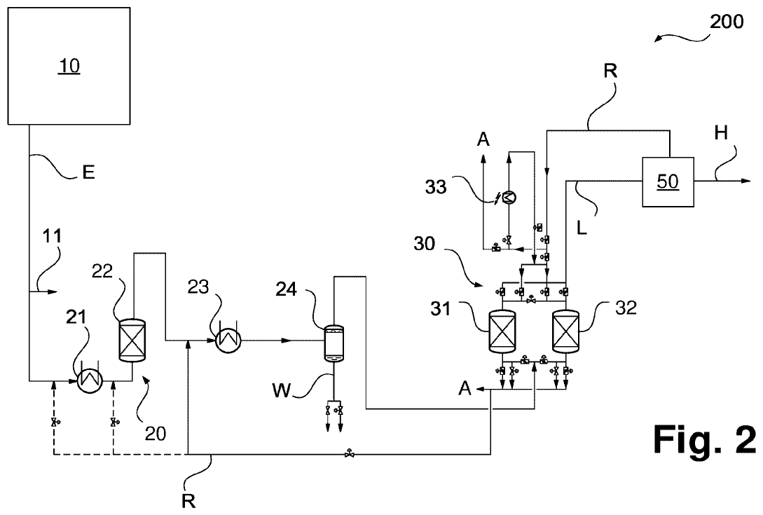

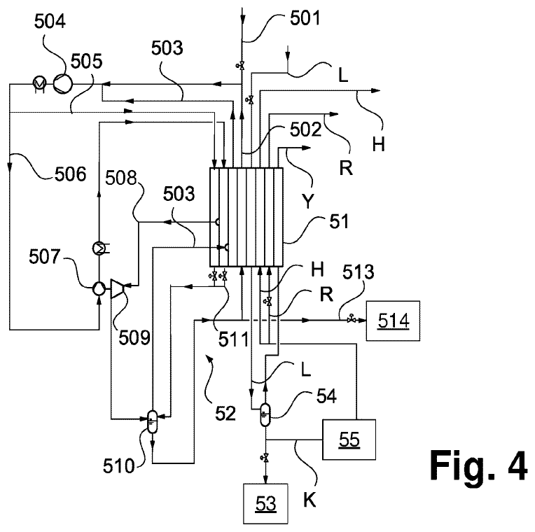

FIG. 2 shows a method 200 according to an embodiment of the invention, in which, in contrast to the method 100 illustrated in FIG. 1, a cryogenic pressure increase 50 is carried out in the manner explained. For further details, reference is particularly made to the explanations relating to FIG. 4.

FIG. 3 shows aspects of a method according to an embodiment of the invention in an alternative representation, wherein in particular a water recirculation is also illustrated. The method steps or system components explained in FIG. 3 can be used in any of the previously explained configurations.

As illustrated here, a fresh water stream F is fed to a water treatment 60. The water treatment 60 can be designed in any desired manner and a condensate stream C formed as explained below can also be fed to it, which can in particular be combined with the fresh water stream F. A pure water stream P formed in the water treatment 60 can in particular be cooled and partly fed into the electrolysis 10.

The electrolysis 10 generates the electrolysis oxygen stream E already mentioned, which is fed to the catalytic hydrogen removal 20 and drying process 30 illustrated here together. Reference is made in this context to the explanations above. Low-pressure oxygen L discharged from the catalytic hydrogen removal 20 and drying process 30 is subjected to a pressure increase 40 or 50 to obtain high-pressure oxygen H, as already explained in relation to FIGS. 1 and 2 and to FIG. 4. A hydrogen stream is denoted by X.

The regeneration gas R previously used in the temperature swing adsorption or drying process 30 is cooled in a cooler designated here by 65, for example with cooling water, and fed into a separator 66, where a condensate phase separates out. This can be returned to the water treatment 60 in the form of the condensate stream C in the manner explained. A gas fraction from the separator 66 consists substantially of hydrous oxygen. It can be recycled in the form of the material stream O, as previously explained. As an alternative to the treatment of the condensate stream C, a direct recirculation can also be carried out, as illustrated by a dashed arrow.

FIG. 4 shows a cryogenic compression 50 according to an embodiment of the invention. The low-pressure oxygen L is supplied to a heat exchanger 51 on the hot side and removed from it on the cold side. The heat exchanger 51 is operated with a nitrogen circuit 52. A liquid reservoir 53 is optionally provided. The low-pressure oxygen L, which is removed substantially in liquid form or in the form of a two-phase stream due to the cooling, is fed into a separator 54, where a cryogenic liquid separates out. The cryogenic liquid is pressure-increased in the form of a material stream K by means of a pump 55 or by means of a pressure build-up evaporator 55. To provide the regeneration gas R, a portion of it can be throttled off, the remainder forms the high-pressure oxygen stream H. These oxygen streams and a gas stream Y from the top of the separator 54 are evaporated in the heat exchanger, if liquid, or converted into the supercritical state. The liquid reservoir 53 can be used in the manner explained above.

The nitrogen circuit 52 can be fed with gaseous nitrogen in the form of a nitrogen stream 501. Together with gaseous or re-evaporated nitrogen streams 502, 503 heated in the heat exchanger 51, this is compressed in a circuit compressor 504 and cooled in an aftercooler not separately designated. A partial stream 505 is cooled to the pressure thereby achieved in the heat exchanger 51, at least partially liquefied therein, removed from the cold side thereof, and fed into a separator 510. A further part 506 is further pressure-increased in a booster 507, after-cooled in an aftercooler (not separately designated) and then also cooled to the pressure thereby achieved in the heat exchanger 51, wherein a partial stream 508 is taken from the heat exchanger 51 at an intermediate temperature, expanded in a turbine 509 coupled to the booster 507 and fed into the separator 510, and a partial stream 511 is taken from the cold side of the heat exchanger 51 and also fed into the separator 510. The partial streams 508 and 511 are also at least partially liquefied in the previous steps.

Gas from the top of the separator 510 forms the already mentioned material stream 503, liquid from the sump is partially re-evaporated in the heat exchanger 51 to form the material stream 502. In the case of excess, liquid nitrogen can be fed into a liquid reservoir 514 in the form of a material stream 513. After the nitrogen circuit 52 has been filled for the first time, it can be operated autonomously.

1. A method for providing high-pressure oxygen (H) using low-pressure oxygen (L) containing water, in which the low-pressure oxygen (L) is subjected to a drying process and then to a pressure increase, wherein the drying process comprises an adsorption step, wherein, in the adsorption step a regeneration gas (R) is used which is provided using oxygen which is provided using the pressure increase and using at least a part of the low-pressure oxygen (L), wherein the pressure increase is performed above 0° C. and using a plurality of compressors or compressor stages which have an intercooler between two compressors and/or compressor stages, and in which at least a part of the oxygen used to form the regeneration gas (R) is removed from the pressure increase between two of the compressors or compressor stages upstream of the intercooler.

2. The method according to claim 1, wherein the adsorption step comprises a temperature swing adsorption and/or a pressure swing adsorption.

3. The method according to claim 1, wherein the regeneration gas is at least partially returned to the method after its use in the temperature swing adsorption.

4. The method according to claim 3, wherein water contained in the regeneration gas after its use in the temperature swing adsorption is at least partially returned to the method.

5. The method according to claim 1, in which the low-pressure oxygen (L) is provided at a pressure in a first pressure range, the high-pressure oxygen (H) is provided at a pressure in a second pressure range above the first pressure range, and the oxygen used to form the regeneration gas (R) is provided using the pressure increase at a pressure in a third pressure range between the first and second pressure ranges, or in the second pressure range.

6. The method according to claim 1, in which the regeneration gas (R) is withdrawn upstream of the intercooler during a heating phase in the adsorption step and downstream of the intercooler during the cooling phase in the adsorption step.

7. A method for providing high-pressure oxygen (H) using low-pressure oxygen (L) containing water, in which the low-pressure oxygen (L) is subjected to a drying process and then to a pressure increase, wherein the drying process comprises an adsorption step, wherein, in the adsorption step, a regeneration gas (R) is used which is provided using oxygen which is provided using the pressure increase and using at least a part of the low-pressure oxygen (L), wherein the pressure increase comprises cryogenically liquefying at least a part of the low-pressure oxygen (L) subjected to the drying process and then the pressure increase to obtain a cryogenic liquid, pressurizing at least a part of the cryogenic liquid in the liquid state to obtain a pressurized, cryogenic liquid, and converting at least a part of the cryogenic and pressurized cryogenic liquid into the gaseous or supercritical state.

8. The method according to claim 7, wherein the cryogenic liquefaction is performed using a heat exchanger operated with a nitrogen refrigeration circuit.

9. The method according to claim 8, wherein at least a part of the pressurized cryogenic liquid and at least a part of the oxygen used to form the regeneration gas (R) are heated in the heat exchanger.

10. The method according to claim 7, which comprises temporarily storing the cryogenic liquid in a liquid reservoir.

11. The method according to claim 1, in which the low-pressure oxygen (L) is provided using electrolysis oxygen (E) which is provided using an electrolysis.

12. The method according to claim 11, in which at least a part of the electrolysis oxygen (E) is provided as hydrogen-containing electrolysis oxygen (E), wherein the hydrogen is at least partly converted to water using a catalytic hydrogen removal, which is followed by cooling and water separation, and in which the water is at least partly removed in the drying process, wherein the catalytic hydrogen removal is in particular preceded by a heat exchanger which heats the low-pressure oxygen to a temperature which is at least 15° C. above the dew point and which is in particular predominantly or exclusively driven by electricity.

13. The method according to claim 11, wherein the electrolysis is carried out using a proton exchange membrane and/or an alkaline electrolysis.

14. A system for providing high-pressure oxygen (H) using low-pressure oxygen (L) containing water, which is designed to subject the low-pressure oxygen (L) to a drying process and then to a pressure increase, and to carry out the drying process using a temperature swing adsorption, wherein, the system is designed to use a regeneration gas (R) in the temperature swing adsorption, to form the regeneration gas (R) using oxygen, and to provide the oxygen used to form the regeneration gas (R) using the pressure increase and using at least a part of the low-pressure oxygen (L), wherein a device is used for the pressure increase, the device having
a plurality of compressors or compressor stages, and
an intercooler arranged between two compressors and/or compressor stages
and—between two of the compressors or compressor stages upstream of the intercooler—there is a means for removing at least part of the oxygen used to form the regeneration gas (R),
wherein the device for the pressure increase is designed for compression above 0° C.

15. The system for providing high-pressure oxygen (H) using low-pressure oxygen (L) containing water, which is designed to subject the low-pressure oxygen (L) to a drying process and then to a pressure increase and to carry out the drying process using a temperature swing adsorption, wherein, the system is designed to use a regeneration gas (R) in the temperature swing adsorption, to form the regeneration gas (R) using oxygen, and to provide the oxygen used to form the regeneration gas (R) using the pressure increase and using at least a part of the low-pressure oxygen (L), wherein the pressure increase comprises cryogenically liquefying at least a part of the low-pressure oxygen (L) subjected to the drying process and then the pressure increase to obtain a cryogenic liquid, pressurizing at least a part of the cryogenic liquid in the liquid state to obtain a pressurized, cryogenic liquid, and converting at least a part of the cryogenic and pressurized cryogenic liquid into the gaseous or supercritical state.
